(19) United States
(12) Patent Application Publication
(10) Pub. No.: US 2008/0038438 A1
(43) Pub. Date: Feb. 14, 2008

(54) Portionable, Rapid Melt Dairy Based Product

(76) Inventors: Deborah P. Moore, Fredonia, WI (US); Phillip Delpierre, Plymouth, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/463,351

(22) Filed: Aug. 9, 2006

(51) Int. Cl. A23L 1/05

(52) U.S. Cl. 426/576; 426/582

(57) ABSTRACT

A process for a portionable, rapid melt sauce is disclosed which forms a gel, to which additional ingredients of the sauce are then added. After formation of the mixture, it may be homogenized and refrigerated to make the resulting product sufficiently firm to allow it to be processed into segments of a desired size, such as small cubes, shreds, or another portionable shape. The product may then be packaged either into individualized portions, or into larger sizes if desired. The small solid segments contained may be portioned out as desired, and rapidly melt into a sauce when heated or when placed onto hot food and will preferably remain as a sauce at room temperature.

### BACKGROUND OF THE INVENTION

### Field of the Invention

The present invention relates generally to foods and sauces, and more particularly to a dairy-based sauce and cheese that is easily portionable and that will rapidly melt when it is heated or when it is placed on hot food items, and to a related method for making these dairy-based sauces and cheeses.

Dairy-based ingredients, such as sauces and garnishes made with cheese, are very popular among consumers. Included are slices or cubes of cheese, spoonable sauces made from cheese, and shredded toppings made from cheese. Cheese-type toppings or sauces are popular because of their excellent properties. These properties include excellent taste, and of course, the variety of cheese types and tastes available. Cheese also has excellent nutritional benefits, such as calcium. Finally, the color itself of the cheese usually provides a desirable and pleasing contrast to the food which it tops, such as a saffron cheese sauce on bright green broccoli.

One problem with dairy-based sauces, and with cheeses, as shown in these examples, is the difficulty of furnishing a small, individualized portion of the cheese or sauce. For instance, a slice or cube of cheese is typically taken from a block or larger piece, which may not be available in all circumstances. A spoonful or two of spreadable sauce may be taken from a sauce-pan or from a jar of sauce. The sauce may be separated and packaged into small one ounce or other size packets, but sometimes it is difficult to dispense the sauce, or the packet itself may require preheating in order to dispense. If the sauce is dehydrated or otherwise dried and formed into a powder, reconstituting the sauce may require additional inconvenient preparing steps before consumption.

The prior art includes many cheeses and methods for processing cheese, but does not include ways to easily or individually apportion the cheese without incurring substantial disadvantages. For example, U.S. Pat. No. 2,279,202 teaches shredding or grating cheese and then individually coating each cheese particle with a coating of fat to protect the cheese and help prevent its deterioration over time. This is clearly undesirable, and in any case, may be limited to harder cheeses.

In another example, U.S. Pat. No. 5,766,657 discloses melt-controlled cheese that is formed by integrating two or more cheese curds having different melt values. In one example, a curd produced by adding acid to hot milk is mixed with a curd produced by rennet coagulation. Cheeses with a relative high melt value produced by rennet coagulation are mixed in a desired proportion with cheese of relatively low melt value produced by the heated milk process. The resulting mixture has a relatively predictable melt value, but at the cost of a very complicated process.

U.S. Pat. No. 5,985,350, includes sauces that may include cheese. The sauce is made from a thickener and other ingredients, but in order to prepare individual portions, the sauce would have to be packaged into individual small packets. This liquid sauce is not easily apportioned and must then be squeezed from the packets.

U.S. Pat. No. 6,524,636 discloses a process for producing frozen chips of a savory sauce. The chips are produced by preparing a sauce and then spraying and freezing it into small chips on a chilled stainless steel belt. The sauce may also be prepared as two types of chips, prepared and frozen separately, and then mixed in a packet or on the food item itself. These chips must be frozen until they are needed, and are thus inconvenient.

What is needed is a better cheese or dairy based sauce or product that will rapidly melt when placed upon hot food or when heated. It is also desirable that the product be readily portionable so that a container of the product may be easily separated into individualized or other portions. Dairy-based sauce and cheese embodiments according to the present invention, made of a plurality of small discrete pieces, must continue to be economical in their cost, and must also continue to have excellent flavor, mouth-feel, and other consumer-preferred properties. The advantages of embodiments according to the present invention should be achieved without incurring any substantial relative disadvantage.

### SUMMARY OF THE INVENTION

The disadvantages and limitations of the background art discussed above are overcome by the present invention. The present invention provides a rapid melt dairy based product and a method of making such a rapid melt dairy based product which at room temperature is a solid, easily portionable product, but which melts quickly into a sauce upon heating or when dispensed directly onto hot food. Once melted, the rapid melt dairy based product remains in sauce form and does not congeal at room temperature.

One embodiment is a method for preparing a portionable, rapid melt dairy based product. The method includes steps of adding a gelatin to water, allowing the water and gelatin to hydrate, blending in a fat, forming a mix by adding dry ingredients, at least one of the dry ingredients including a dairy based product, and heating. The method also includes steps of optionally homogenizing the mix, refrigerating the mix, and processing the mix into a desired solid size, wherein the pieces are solid at room temperature.

Another embodiment is a portionable, rapid melt dairy product. The dairy product includes about four to five percent gelatin, about forty-five to about fifty percent moisture, about twenty-five to about thirty-five percent fat, and about ten to fifteen percent protein, wherein the product includes a plurality of sprinklable small pieces that are solid at room temperature.

Another embodiment is a sprinklable dairy product. The dairy product includes about four to seven percent gelatin, about forty-five to fifty-five percent moisture, about twenty to forty percent fat, and about five to twenty percent protein, wherein the dairy product includes a plurality of small pieces that are solid at room temperature.

It may therefore be seen that one embodiment of the present invention teaches a method for making a dairy product that is easily portionable and that will rapidly melt when heated or when placed on hot food items. Other embodiments of the invention are a portionable dairy product that includes small pieces that are solid at room temperature, and therefore easily portionable or sprinklable, rather than liquid. A packet of the portionable, rapid melt product may be sprinkled onto a diner's plate, in a manner similar to a small packet of ketchup at a fast-food restaurant.

Rather than squeezing or pouring out a messy liquid or paste, however, a discrete number of pieces, such as shreds or dice (small dies or cubes of the dairy product), will pour from the packet. If the packet is small, perhaps one-half ounce to one ounce, the diner may wish to sprinkle the entire packet. If the packet is large, perhaps several ounces, the diner may merely wish to portion out a few sprinkles, saving the rest for other diners or for a later occasion.

The word “solid” as used herein means that the dairy product is non-liquid and of course, non-gaseous. The cheese or dairy product will be sufficiently solid that once placed into a packet or envelope, a small quantity may be removed from the packet by shaking, rather than squeezing. Careful handling, or even refrigeration, may be necessary with the product. Because of the nature of cheese or dairy products, the small pieces may melt and cling together if pressure and heat are applied merely by squeezing a small quantity of the pieces.

The rapid melt dairy based product of the present invention is of high quality and will remain as a sauce once it is heated or applied to a hot food, and will not become congealed. The rapid melt dairy based product of the present invention is relatively economical to manufacture to enhance its market appeal and to thereby afford it the broadest possible market. Finally, all of the aforesaid advantages of the rapid melt dairy based product of the present invention are achieved without incurring any substantial relative disadvantage.

### DESCRIPTION OF THE DRAWINGS

These and other advantages of the present invention are best understood with reference to the drawings, in which:

FIG. 1 is a flow chart depicting one method of making a cheese or dairy product according to the teachings of the present invention.

### DETAILED DESCRIPTION OF THE PREFERRED EMBODIMENT

The preferred embodiment of the present invention provides a rapid melt dairy based product that is solid at room temperature and is easily portionable, but that when heated or when dispensed onto hot food melts quickly into a sauce and remains in sauce form and does not congeal at room temperature. The rapid melt dairy based product uses a gelatin, either with or without a starch as a base, to produce a dairy-based sauce that becomes very firm or hard when refrigerated and cured. This rapid melt dairy based product may then be machined or processed into reduced size particles and packaged. Consumers may then easily dispense and consume the rapid melt dairy based product.

For example, a cheddar-cheese based product, which is discussed in detail below, may be formed and refrigerated, and then diced into cubes, about one-eighth inch to one-quarter inch on each side, or larger. These cubes may be placed into an individual one ounce packet, a larger eight ounce packet, a two pound container, or any other desired size package. When a consumer wishes to add a cheddar-based sauce to a broccoli, eggs, or another hot food product, the consumer may open the packaging and shake a desired quantity of the small cubes onto the hot food. In a preferred embodiment, the small cubes have a sufficiently low softening point that the cubes will melt into a sauce and spread onto the hot food. In another embodiment, the consumer may take the food item with small cheese cubes placed thereupon and heat the food item and the small cubes briefly, typically in a microwave oven, to melt the small cheese cubes into a sauce that will spread evenly over the food.

In the preferred embodiment, a stabilizer system helps to form and firm the cheese or sauce product. The stabilizer system preferably uses a blend of a gelatin and a starch or other carbohydrate. If no starch or other carbohydrate is used, the stabilizer will be less firm, and a thinner, “finishing” sauce or dairy based product will be formed. The stabilizer system substantially firms or hardens the product in its bulk form so that it becomes very firm or hard when it is later refrigerated and cured. The product may then be easily machined into smaller pieces, such as by slicing, dicing, shredding, crumbling, or comminuting, i.e., pulverizing, or through the use of any other suitable size-reducing forming technique.

Formulations of the dairy based sauce preferably also use one or more cheeses, dairy powders, or dairy fats, although nondairy sauces can also be made using the teachings of the present invention. In one embodiment, one or more of the following cheeses may be added to the sauce: Asiago cheese, blue cheese, brick cheese, Swiss cheese, Edam cheese, Gouda cheese, Muenster cheese, Mozzarella cheese, Parmesan cheese, Provolone cheese, Romano cheese, American cheese, Cheddar cheese, Colby cheese, Monterey Jack cheese, wash curd cheese, stirred curd cheese, or any other desired type of cheese.

In other embodiments, dairy powders or dairy fats may be used. For example, powdered casein products may be used, e.g., complete milk protein, e.g., CMP-GP eighty percent, an ultrafiltered natural milk protein isolate in fine powder form, from American Casein Co., of Burlington, N.J. Other useful powders that may be used include nonfat skim dry milk and dairy powders. Thickeners, gelling agents, pH adjusters, preservatives, emulsifiers, flavor modifiers, and colorants may also be added.

A variety of dairy fats also add to the texture, flavor, and consistency of the product. Preferred dairy fats are heavy whipping cream and plastic cream (plastic cream is a product formed during the separation of whole milk) Plastic cream typically has a fat content approaching eighty percent, but it remains as an oil-in-water emulsion in which the fat is still in the form of globules and the skim milk is the continuous phase of the emulsion. Other dairy fats may also be used instead.

Such other fats may also be used to produce lower-cost sauces and cheeses. For instance, vegetable fats, such as shortening, may be used instead of dairy fats.

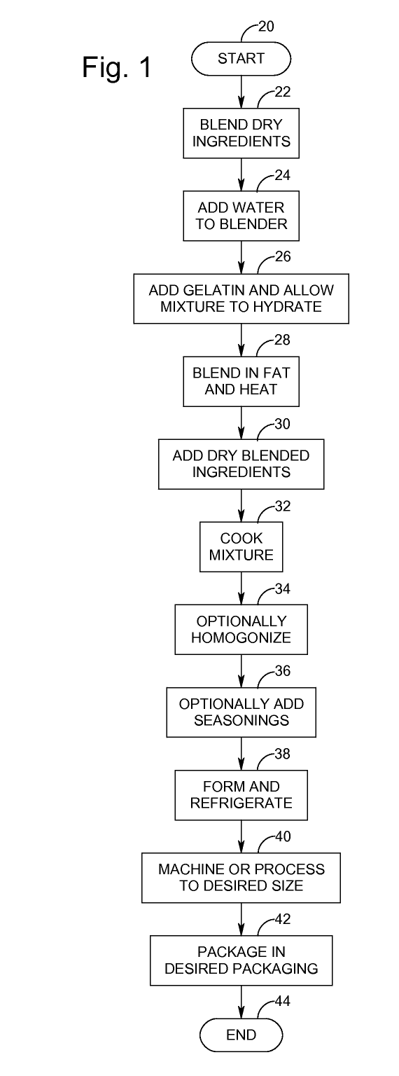

FIG. 1 is a flowchart depicting the process described above. The process begins with a process initiation step 20, and moves to a blend dry ingredients step 22 in which all of the dry ingredients except for the gelatin and optional seasonings are blended together. Next, in an add water step 24, water is added to a cooker, or, in production-sized equipment, a blender.

After adding the water, in an add gelatin and hydrate step 26, gelatin is added to the water and blended (with slow agitation) about one minute to cause the gelatin to hydrate. Once the gelatin is hydrated, the fat, such as dairy fat or vegetable fat is blended into the mixture and heated in a blend fat and heat step 28. Following hydration of the fat, the dry blended ingredients may be blended into the mixture in a blend additional dry ingredients step 30, and then cooked in a cook mixture step 32.

Next, the blend may be homogenized in an optional homogenize step 34, which preferably occurs in two stages (at one thousand psi for the first stage and two hundred fifty psi for the second stage), although strictly speaking homogenizing is not required. After homogenizing, a flavor modifier or other seasonings may be added in an optional add seasonings step 36. In this step, spices, herbs, or other particulates such as dried vegetables and/or fruits and nuts may optionally be added. Examples of spices and herbs that may be added include garlic, basil, cilantro, jalapenos, oregano, tomato powder, onion powder, bell peppers, cilantro, garlic, celery, parsley, salt, pepper, and sugar. Examples of other particulates that may be added include sun-dried tomatoes, garlic, basil, dehydrated tomatoes, cilantro, jalapenos, hot peppers, sweet peppers, mushrooms, and onions. It should be noted in passing that the addition of the flavor modifier and/or seasonings may instead take place at other points in the process.

The dairy product may then be separated into a desired number of smaller quantities, such as two pound loaf boxes, thirty to forty pound boxes, or trays of a larger quantity, such as seventy-five pound trays, and refrigerated in a form and refrigerate step 38. After refrigeration and curing for a sufficient time (the cheese becomes firmer over time due to the stabilizer), the cheese is sufficiently firm so that it can be processed in a machine or process to desired size step 40 into slices, dice, shreds, or any other desired small size configuration. Those skilled in the art will appreciate that the cure time must be sufficiently long to allow the cheese to become sufficiently firm to render the cheese convertible, and not so long that the time required for curing substantially increases the cost of manufacturing the cheese.

Firmness of the cheese may be measured with a cone penetrometer such as the universal penetrometer available from Universal Scientific Petroleum Instruments with a needle, per ASTM D 5, 2.5 gram tapered 0.040 inch to 0.006 inch, at thirty-eight degrees Fahrenheit with a dropping assembly mass of 100 grams, after a period of ten seconds. Acceptable readings of firmness require a penetrometer reading of less than about sixteen millimeters, with the preferred range being between six and ten millimeters. Cheese which is insufficiently firm is particularly difficult to convert, and cheese which is too firm may not possess desired melting characteristics.

Finally, the cheese is packaged for sale in a packaging in desired packaging step 42, following which the finished product may be refrigerated or frozen. The process then ends in a process termination step 44. As specific illustrations of portionable, rapid melt dairy products, three examples (which are illustrative of and in no way limit the present invention) are provided hereinbelow.

### EXAMPLE 1

A first example is a cheese sauce made with Parmesan cheese, which typically tends to be a harder cheese, using the ingredients that are shown in Table 1 below.

The Parmesan sauce is prepared in the following manner. All of the dry ingredients are preblended except for the gelatin and the seasonings. Water is added to a laboratory cooker, and gelatin is then added to the cooker and allowed to hydrate with slow agitation for about one minute. Heavy cream is then added slowly to the gelatin/water mix and is allowed to blend thereinto. The dry blended ingredients are then added, and blending is continued. The plastic cream and flavor are then added and blended, and heating is begun. Hydration of the gelatin may take place in about one to five minutes depending on the gelatin used and the water temperature.

TABLE 1

| | Input, percent |
|---|---|
| Ingredient | |
| Heavy whipping cream | 42.00 |
| Plastic cream | 12.84 |
| Water | 13.25 |
| Steam | 7.50 |
| Parmesan, fine grated | 9.00 |
| Parmesan cheese powder | 5.00 |
| (BDF) | |
| Gelatin, 300 Bloom | 4.50 |
| Natural Asiago cheese | 0.50 |
| type flavor | |
| Sorbic Acid | 0.20 |
| Italian Herb Seasoning | 2.00 |
| Salt | 1.40 |
| CMP-GP 80% | 1.06 |
| Nonfat dry skim milk | 0.75 |
| Comments/Instructions | |
| pH | 5.26 |
| % Moisture | 47.7 |
| % Salt | 2.52 |
| % Fat | 26.5 |

The cooker is heated to one hundred eighty-four degrees Fahrenheit with steam. In production equipment, the blending will preferably be accomplished in an unheated blender and then the blend transferred to a cooker for heating. The temperature used for heating in a production cooker may vary from as low as one hundred sixty degrees Fahrenheit, to possibly as high as one hundred ninety degrees Fahrenheit. What is important is that the gel be hydrated and that the blend be properly cooked, rather than requiring any particular temperature.

The batch is then optionally homogenized in two stages, at one thousand psi for the first stage and two hundred fifty psi for the second stage (250/1000). The seasonings are then added to the batch, which is subsequently divided into two pound loaf boxes and refrigerated to cool it and thereafter to allow it to cure. The curing process must be for a sufficiently time to allow the product to become sufficiently firm to render the product easily convertible into finely divided, portionable, segments. It will be recognized by those skilled in the art that excessively long curing times substantially increase the cost of manufacture.

Alternatively, cooling of the batch may instead be accomplished using a chill roll, which is an apparatus that is commonly used in the making of process cheese slices. The batch of product may be extruded through a chill roll having two spaced-apart rollers which have low temperature coolant flowing therethrough to rapidly cool the batch of product as it flows through the chill roll. The chill roll thus acts as a heat transfer device in such an extrusion operation, with the cooled sheet of product from the chill roll then being run into a bulk container, pressed together, and allowed to cure.

The cheese may then be processed in several different ways, each of which is satisfactory in producing a finely divided, portionable, rapid melt dairy product. The product from may be diced into small cubes, about one-eighth inch on each side. Alternatively, the product may instead be: sliced into slices about one-half inch on a side, one and one-half inches long; shredded into shreds of Parmesan cheese about one-sixteenth inch in diameter; cut into three and one-half inch by three and one-half inch slices of various thicknesses; or diced into larger cubes about three-eighths inch on a side. All of the aforesaid machining methods worked well with this formula.

In a production environment, the product may be separated into boxes or trays, such as thirty to forty pound roughly cubic “boxes” or seventy-five pound trays. Other convenient equipment may be used, with the understanding that with larger boxes or trays, refrigeration and curing will take longer. Refrigeration temperature preferably ranges from about thirty-eight to about forty-five degrees Fahrenheit. Other temperatures may be used so long as the cheese does not freeze and the cheese is sufficiently firm for later processing.

### EXAMPLE 2

A second example uses Parmesan cheese, which also tends to be a harder cheese, and cheddar cheese flavoring, with the complete list of ingredients being listed in Table 2.

TABLE 2

| | Input, percent |
|---|---|
| Ingredient | |
| Shortening, liquid code | 22.51 |
| 123 | |
| Water | 39.01 |
| Steam | 7.32 |
| Parmesan, fine grated | 8.78 |
| Parmesan cheese powder | 4.88 |
| BDF 0004 | |
| Gelatin, 300 Bloom | 4.40 |
| Jeneil Cheddar EMC3020 | 1.50 |
| Sorbic acid | 0.30 |
| Apo-carotenal | 0.13 |
| Salt | 1.75 |
| CMP-GP 80% | 1.96 |
| Starch - Penbind 800 | 2.75 |
| Starch - Pencook 37 | 0.25 |
| Disodium phosphate | 1.00 |
| Trisodium phosphate | 0.50 |
| Nonfat dry skim milk | 1.96 |
| Lactic Acid 50% | 0.99 |
| Comments/Instructions | |
| pH | 5.38 |
| % Moisture | 46.9 |
| % Salt | 2.68 |
| % Fat | 32.5 |

The product in this second example was made in a manner similar to the first example. All dry ingredients except the gelatin, including the flavors, were blended together and placed in a laboratory cooker. Water was added to the cooker and the gelatin was added to the cooker and allowed to hydrate for one minute with slow agitation. The shortening was then added and allowed to blend. Heating was then begun and the dry ingredients were blended while heating them to one hundred eighty-four degrees Fahrenheit with steam. The batch was then separated as before, and the batch was homogenized in a two stage process at one thousand five hundred psi and five hundred psi (500/1500). The batches were then packaged separately into two pound loaf boxes and refrigerated and cured. After refrigeration and curing, the dairy product was processed, i.e., divided, using several different methods as outlined above, all of which were satisfactory.

In the second example, disodium phosphate and trisodium phosphate were added as emulsifiers, to assist in the blending of the dairy product with the gelatin and water. Other emulsifiers that may be used include, but are not limited to, monosodium phosphate, other phosphate salts, and sodium citrate. Lactic acid may be used as a pH modifier. Other pH modifiers that may be used include acetic acid, citric acid, and phosphoric acid, although lactic acid is preferred. In addition, adding three percent starch by weight made the cheese much harder. More starch, up to nine percent, may be added.

### EXAMPLE 3

A third example uses Parmesan cheese and Butter Buds flavoring, with the ingredients being listed in Table 3.

The dairy product in this third example was made in a manner similar to the first and second examples. All dry ingredients, except the gelatin and the Chr. Hansen Dairy Powder 891 flavor modifier were blended together. Water was added to the cooker and the gelatin was added with slow agitation and allowed to hydrate for about one minute. The shortening was then added to the gelatin/water mixture and allowed to blend with slow agitation. Heating was then begun and the dry ingredients were then added by blending with slow agitation. The cooker was heated to one hundred eighty-four degrees Fahrenheit with steam.

After heating, the batch was homogenized at one thousand psi for the first stage and two hundred fifty psi for the second stage and four-tenths of a percent by weight of Chr. Hansen Dairy Powder 891 flavor modifier was added to the batch. The batch was then packaged and refrigerated and cured. After refrigeration and curing, the product was processed, i.e., divided, using the methods as outlined above, all of which were satisfactory.

TABLE 3

| | Input, percent |
|---|---|
| Ingredient | |
| Shortening, liquid code | 27.77 |
| 123 | |
| Water | 40.46 |
| Steam | 7.50 |
| Parmesan, fine grated | 5.47 |
| Parmesan cheese powder | 4.80 |
| BDF 0004 | |
| Gelatin, 300 Bloom | 4.50 |
| Teklac sweet dairy whey | 2.00 |
| #373 | |
| Butter Buds 32x | 0.25 |
| Sorbic acid | 0.30 |
| Apo-carotenal | 0.10 |
| Salt | 2.20 |
| CMP-GP 80% | 2.25 |
| Satialgine S1100 | 0.40 |
| Nonfat dry skim milk | 2.00 |
| Chr. Hansen Dairy Powder | 0.40 |
| 891 | |
| Comments/Instructions | |
| pH | 5.4 |
| % Moisture | 46.8 |
| % Salt | 2.88 |
| % Fat | 33.5 |

It has been found that the preferred products made according to these recipes and procedures use a high-strength gel, e.g., a gel with a Bloom rating of two hundred or greater. A Bloom rating of three hundred is preferred. It has also been found that type A collagen gelatin is preferred. This type gelatin is typically made from porcine skin, cow-hide, or bones of animals aged six months or greater. The isoelectric point of the preferred gelatin tends to be about 4.5 to about 5.5, and the pH may range from about 4.5 to about 7.5, more preferably about pH 5.2 to about 6.2.

Other gelatins may be used instead or in addition, such as another collagen-product gelatin, carrageenan, pectin, agar, a derivative of a collagen product, a derivative of a carrageenan, and a derivative of an agar.

It has been found that sauces and dairy products made according to the invention may also contain additional ingredients to stabilize and firm up the product. These stabilizers/thickeners may include starches or other products. Stabilizers/ thickeners may also include guar gum, derivatives of guar gum, carboxymethyl cellulose and its derivative products, and other celluloses, such as hydroxymethyl cellulose and its derivatives.

Alginates, such as sodium alginates, may function as thickeners, and may be used, preferably as a thickener in dairy product and sauce embodiments of the present invention. Some products may be used as thickeners, and are useful in the dairy product embodiments. These include pectin, carrageenan, and agar, locust bean, tara, and xanthan gums, and their derivatives. These ingredients may be used as an additional stabilizer/thickener in the latter stages of blending. Some of these which form a gel, such as pectin, carrageenan, and xanthan and agar gums, may be used in minor proportions together with the gelatin in the gel-forming first step of the process.

Once the dairy product or cheese has been formed, as outlined above, and refrigerated and cured, the product is easily machined or cut into small pieces, e.g., diced, sliced, shredded, crumbled, pulverized, or otherwise suitably formed. The pieces may then be easily apportioned and packaged for an individualized or family-size portions. When desired, irregularly shaped pieces, small cubes, or shreds may later be portioned, i.e., shaken out of the packet and onto a food product, for use as a sauce or topping.

Depending on the firmness or “solidness” of the product or sauce, and the temperature of the food onto which the sauce is sprinkled or shaken, the sauce may melt and spread on its own. If the sauce is more firm, then further heating, such as in a microwave oven or conventional oven, may be required to melt and spread the sauce. Dairy products made according to the present invention preferably include a preservative in small amounts, of about 0.10 to about 0.50 percent, preferably about 0.20 to about 0.30 percent. Suitable preservatives include, but are not limited to, sorbic acid, benzoic acid, and sodium benzoate.

The pH of the resulting product is preferably in the range of about pH 5.1 to 5.8, more preferably about pH 5.2 to 5.5, and most preferably about 5.25-5.4. It may be useful to add small amounts of a pH or acidity regulator, such as lactic acid.

The examples above used a strong gelatin, three hundred Bloom, and four to five percent was sufficient to achieve the properties desired in the finished dairy product. Gelatins of lesser strength may be used instead, with a correspondingly higher amount. For instance, if two hundred fifty bloom gelatin is used, the amount should probably be adjusted to about four and one-half to five and one-half percent by weight.

If two hundred Bloom gelatin is used, the amount of gelatin should probably be about five to six percent. Using weaker gelatins, with Blooms of fifty to one hundred, it is possible that an amount of up to seven percent of gelatin may be possible (or needed). Of course, with such a high quantity of gelatin, the cheese may also tolerate a higher moisture content. Thus, in some dairy based sauce embodiments, in which a looser or lower-melting portionable, rapid melt sauce is desired, moisture contents of as high as fifty or fifty-five percent may be possible. All these embodiments are meant to be included, so long as the resulting cubes, slices, shreds, or particles are easily portionable and will rapidly melt when heated or placed on hot food items.

Thus, it will be appreciated by those skilled in the art that the present invention provides a rapid melt dairy based product that is solid and easily portionable at room temperature, but that when heated or when dispensed onto hot food melts quickly into a sauce and remains in sauce form and does not congeal at room temperature. The rapid melt dairy based product uses a gelatin, either with or without a starch as a base, as a stabilizer to produce a sauce that becomes sufficiently firm to process when refrigerated. It may then be processed into reduced size segments and packaged. In use, it may be easily dispenses and will rapidly melt into a sauce when heated or when dispensed onto hot food, and once melted it will remain as a sauce at normal room temperatures.

All references, including publications, patent applications, and patents cited herein are hereby incorporated herein by reference to the same extent as if each reference were individually and specifically indicated to be incorporated by reference herein and were set forth in its entirety herein. Except where specified, the steps of a method need not be performed in the precise order given in the method.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Although the foregoing description of the portionable, rapid melt dairy-based food product of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A method for preparing a portionable sauce product comprising a plurality of small segments that are solid at room temperature until heated or placed upon hot food, at which time they become a sauce, said method comprising:
adding a gelatin to water;
allowing said gelatin and said water to hydrate;
blending a fat into the hydrated gelatin and water;
forming a mixture by adding dry ingredients to the hydrated gelatin and water and fat and heating the mixture;
refrigerating said mixture at least for a period of time sufficient for said mixture to become sufficiently firm to allow it to be processed; and
when said mixture has become sufficiently firm, processing said mixture into a plurality of small segments, said small segments being solid at room temperature.

2. A method as defined in claim 1, wherein the portionable sauce product is processed into said plurality of small segments of a desired size by machining, dicing, shredding, slicing, or comminuting said mixture.

3. A method as defined in claim 1, wherein said gelatin is selected from a substance from the group consisting of a collagen product, carrageenan, pectin, agar, a derivative of a collagen product, a derivative of a carrageenan, and a derivative of an agar.

4. A method as defined in claim 1, wherein said dry ingredients comprise a thickener.

5. A method as defined in claim 1, wherein said dry ingredients comprise at least one cheese in grated or powder form.

6. A method as defined in claim 1, wherein said dry ingredients comprise seasonings.

7. A method as defined in claim 1, wherein said dry ingredients comprise spices, herbs, dried vegetables particulates, dried fruit particulates, or nuts, or any combination thereof.

8. A method as defined in claim 1, wherein the pH of said mixture is maintained at or below about pH 5.8.

9. A method as defined in claim 8, wherein said pH of said mixture is maintained at or about pH 5.1 to pH 5.8.

10. A method as defined in claim 9, wherein said pH of said mixture is maintained at or about pH 5.2 to pH 5.5.

11. A method as defined in claim 1, additionally comprising:
homogenizing said mixture prior to said refrigerating step.

12. A method as defined in claim 1, wherein said small segments quickly melt to become a sauce when heated or when placed upon hot food, and thereafter remain in sauce form at room temperature.

13. A method as defined in claim 1, wherein said refrigerating step is performed for a period of time sufficient to allow said mixture to reach a level of firmness associated with a penetrometer reading of less than about sixteen millimeters with a needle, per ASTM D 5, 2.5 gram tapered 0.040 inch to 0.006 inch, at thirty-eight degrees Fahrenheit with a dropping assembly mass of 100 grams, after a period of ten seconds.

14. A method as defined in claim 13, wherein said refrigerating step is performed for a period of time sufficient to allow said mixture to reach a level of firmness associated with a penetrometer reading of between about six and ten millimeters with a needle, per ASTM D 5, 2.5 gram tapered 0.040 inch to 0.006 inch, at thirty-eight degrees Fahrenheit with a dropping assembly mass of 100 grams, after a period of ten seconds.

15. A portionable sauce product, comprising:
about four to five percent gelatin;
about forty-five to about fifty percent moisture;
about twenty-five to about thirty-five percent fat; and
about ten to fifteen percent protein;
wherein the portionable sauce product comprises a plurality of small segments that are solid at room temperature until heated or placed upon hot food, at which time they become a sauce.

16. A portionable sauce product as defined in claim 15, further comprising zero to about nine percent of a starch.

17. A portionable sauce product as defined in claim 15, wherein said fat is a dairy fat, a vegetable fat, or a combination of a dairy fat and a vegetable fat.

18. A method of making the portionable sauce product of claim 15, wherein the portionable sauce product is formed by first adding said gelatin to at least a portion of said moisture to form a hydrate, then adding said fat to said hydrate, then adding additional ingredients and any additional moisture to said hydrate and said fat to form a mixture, then refrigerating said mixture, and then processing said mixture into said small segments.

19. A portionable sauce product as defined in claim 15, wherein at least a portion of said protein is selected from the group consisting of Asiago cheese, blue cheese, brick cheese, Swiss cheese, Edam cheese, Gouda cheese, Muenster cheese, Mozzarella cheese, Parmesan cheese, Provolone cheese, Romano cheese, American cheese, Cheddar cheese, Colby cheese, Monterey Jack cheese, wash curd cheese, and stirred curd cheese.

20. A portionable sauce product as defined in claim 15, wherein the pH of the portionable sauce product is between about pH 5.1 and pH 5.8.

21. A method as defined in claim 20, wherein said pH of the portionable sauce product is between about pH 5.2 and pH 5.5.

22. A portionable sauce product as defined in claim 15, further comprising an ingredient selected from the group consisting of a salt, a flavor, a flavor modifier, a thickener, an emulsifier, and a colorant.

23. A portionable sauce product as defined in claim 15, further comprising spices, herbs, dried vegetables particulates, dried fruit particulates, or nuts, or any combination thereof.

24. A portionable sauce product, comprising:
about four to seven percent gelatin;
about forty-five to fifty-five percent moisture;
about twenty to forty percent fat; and
about five to twenty percent protein;
wherein the portionable sauce product comprises a plurality of small segments that are solid at room temperature until heated or placed upon hot food, at which time they become a sauce.

25. A portionable sauce product as defined in claim 24, wherein said gelatin is between two hundred Bloom and three hundred Bloom and comprises about four to six percent.

26. A method of making the portionable sauce product of claim 24, the method comprising first adding the gelatin to the moisture to form a hydrate, then adding the fat to the hydrate, and then adding additional ingredients and moisture.

27. A portionable sauce product as defined in claim 24, comprising about four to five percent gelatin and about forty-five to fifty percent moisture.

28. A portionable sauce product as defined in claim 24, further comprising a thickener selected from the group consisting of guar gum, a derivative of guar gum, carboxymethyl cellulose, a derivative of carboxy-methyl cellulose, hydroxylmethyl cellulose, a derivative of a hydroxymethyl cellulose, an alginate, carrageenan, a derivative of carrageenan, xanthan, a derivative of a xanthan, agar, a derivative of agar, xanthan gum, a derivative of xanthan gum, locust bean gum, a derivative of a locust bean gum, tara gum, a derivative of a tara gum, pectin, a derivative of a pectin, and a starch.

29. A portionable sauce product as defined in claim 24, further comprising about one-quarter percent to about five percent by weight of a thickener.

30. A portionable sauce product as defined in claim 24, further comprising an emulsifier in an amount from zero percent to about three percent by weight.
